(19) United States
(12) Patent Application Publication
(10) Pub. No.: US 2026/0285126 A1
(43) Pub. Date: Sep. 24, 2026

(54) Temperature-Control Device for a Motor Vehicle, in Particular for a Car, and Motor Vehicle Having Such a Temperature-Control Device

(71) Applicant: Bayerische Motoren Werke Aktiengesellschaft, Muenchen (DE)

(72) Inventors: Lukas BERNHAUSER, Ottensheim (AT); Sebastian HAHN, Schwertberg (AT); Stefan HOFMANNINGER, Weibern (AT); Dominik MOSER, Linz (AT); Fisnik SULEJMANI, Linz (AT)

(21) Appl. No.: 19/475,890

(22) PCT Filed: Jun. 14, 2024
(86) PCT No.: PCT/EP2024/066518

§ 371 Date: Oct. 16, 2025

(30) Foreign Application Priority Data
Jul. 7, 2023 (DE) 10 2023 118 019.3

(51) Int. Cl. B60H 1/00; B60K 11/04; G01K 1/02; G01K 3/00

(52) U.S. Cl. CPC B60H 1/00792; B60H 1/00278; B60K 11/04; G01K 1/026; G01K 3/005

(57) ABSTRACT

A temperature-control device for a motor vehicle includes a temperature-control circuit, a temperature detection device, and an electronic computing device configured to operate the temperature-control device. In a first heat pump operating mode, the ambient air cooler, the drive machine, and the first heat exchanger are connected in series and a flow of the temperature-control medium through the energy storage device and the second heat exchanger does not take place. In a second heat pump operating mode, the drive machine and the first heat exchanger are connected in series and a flow of the temperature-control medium through the ambient air cooler, the energy storage device, and the second heat exchanger does not take place.

### BACKGROUND AND SUMMARY

A cooling system for a motor vehicle, having an electrical energy storage device for driving the motor vehicle, can be inferred from DE 10 2017 220 376 A1. Furthermore, DE 10 2019 132 688 A1 discloses a heat management system for a motor vehicle.

An object of the present disclosure is to provide a temperature-control device for a motor vehicle, and a motor vehicle having such a temperature-control device, so that particularly advantageous temperature control, i.e. cooling and/or heating can be implemented.

This and other objects are achieved according to the disclosure by a temperature-control device having the features of this disclosure, and by a motor vehicle having the features of this disclosure. Advantageous embodiments of the disclosure are also the subject matter of this disclosure.

A first aspect of the disclosure relates to a temperature-control device also referred to or designed as a temperature system or temperature-control apparatus. The motor vehicle, the interior of which, which is also referred to as a passenger compartment or passenger space, is formed by a structure of the motor vehicle preferably designed as a self-supporting body of the motor vehicle, is also referred to as a vehicle and is preferably designed as a car, in particular as a passenger vehicle. The motor vehicle is preferably designed as an electric vehicle, in particular as a battery-electric vehicle (BEV), so that the motor vehicle can be electrically driven, in particular driven solely electrically. Furthermore, it is conceivable that the motor vehicle is a hybrid vehicle. At least one section of the motor vehicle, in particular at least one section of the interior of the motor vehicle, can be controlled in temperature, i.e. cooled and/or heated, by means of the temperature-control device. For example, to be able to control the temperature, in particular heat, at least the section of the motor vehicle, i.e., for example, at least the section of the interior, the temperature-control device is operable, for example, in a heat pump mode and therefore as a heat pump, which is also designated as WP. When reference is made above and hereinafter to heating the interior, this is to be understood, if not indicated otherwise, as the above-described heating of at least the section of the interior, so that it is conceivable that the interior can be heated as a whole. The heating of the interior is also referred to as heating up or warming of the interior.

The temperature-control device comprises a temperature-control circuit through which a temperature-control medium, which is preferably liquid, can flow, and which is also simply referred to as a temperature control cycle, cycle, or circuit. The temperature-control medium is preferably a liquid temperature-control medium, therefore a liquid. The temperature-control medium can comprise at least water, for example.

An ambient air cooler is arranged in the temperature-control circuit. The ambient air cooler is to be understood as a heat exchanger, also referred to as a heat exchange unit, which, for example, during a journey and very particularly during a forward journey of the motor vehicle, can have ambient air flow around it, therefore air located in the surroundings of the motor vehicle. In still other words, the ambient air cooler can have travel wind or does have travel wind flow around it during a journey, in particular during a forward journey, of the motor vehicle, which travel wind is formed by air located in the mentioned surroundings of the motor vehicle. The ambient air cooler can have the temperature medium flow through it, so that heat is exchangeable via the ambient air cooler between the temperature-control medium flowing through the ambient air cooler and the air, also referred to as ambient air, flowing around the ambient air cooler, in particular such that heat can pass from the temperature-control medium to the ambient air via the ambient air cooler. The temperature-control medium can be cooled in this way.

A drive machine for driving the motor vehicle is also arranged in the temperature-control circuit. The temperature-control medium can therefore flow through the at least one drive machine, so that the at least one drive machine can be controlled in temperature, i.e. cooled or possibly heated, by means of the temperature-control medium. The at least one drive machine is also referred to as the first drive machine. When reference is made above and hereinafter to the drive machine or to the at least one drive machine, this is to be understood, if not indicated otherwise, as the first drive machine. The drive machine can be designed, for example, as an internal combustion engine, which can also be referred to as a combustion engine. Furthermore, it is conceivable that the drive machine is designed as an electric machine, by means of which the motor vehicle can be electrically driven, in particular driven solely electrically. The electric machine is preferably a high-voltage component, the electric voltage of which, in particular electric operating voltage or nominal voltage, is preferably greater than 50 V, in particular greater than 60 V, and is very preferably several hundred volts. For example, heat can be exchanged between the drive machine and the temperature-control medium flowing through the drive machine, in particular such that heat can alternatively pass from the temperature-control medium to the drive machine or heat can pass from the drive machine to the temperature-control medium, so that the drive machine can alternatively be heated or cooled. For example, if the temperature-control medium has a higher temperature than the drive machine on its path through the drive machine, the temperature-control medium is or functions as a heating medium, by means of which the drive machine can be heated. If the temperature-control medium has, for example, a lower temperature than the drive machine on its path through the drive machine, heat can thus pass from the drive machine to the temperature-control medium, by which the drive machine can be cooled. The temperature-control medium is preferably a component of the temperature-control device.

An electric energy storage device is also arranged in the temperature-control circuit, in or by means of which electrical energy is to be stored or is stored, in particular electrochemically. The electrical energy storage device is very preferably a high-voltage component, the electrical voltage of which, in particular electrical operating voltage and nominal voltage, is preferably greater than 50 V, in particular greater than 60 V, and is very preferably several hundred volts. For example, the above-mentioned electric machine can be supplied with the electrical energy stored in the energy storage device, by which the electric machine can be operated in a motor mode and therefore with an electric motor. By means of the electric motor, the motor vehicle can be electrically driven, for example, in particular solely electrically. For example, the electrical energy storage device comprises multiple storage cells, also referred to simply as cells, which are electrically connected to one another, for example. The above-mentioned electrical energy can be stored, in particular electrochemically, in the storage cells. The energy storage device is also referred to as a battery and, in particular if the electrical energy storage device is a high-voltage component, is a high-voltage battery.

A first heat exchanger, in particular provided additionally to the ambient air cooler, is also arranged in the temperature-control circuit, which first heat exchanger is also arranged in a coolant circuit through which a coolant can flow, so that heat is exchangeable between the coolant and the temperature-control medium via the first heat exchanger. The first heat exchanger is, for example, a chiller or is also referred to as a chiller.

In particular, the coolant circuit is provided in addition to the temperature-control circuit, and very particularly the coolant circuit is fluidically separated from the temperature-control circuit. Heat can be exchanged between the coolant and the temperature-control medium via the first heat exchanger. In particular, for example, the first heat exchanger is or functions as a cooler for the temperature-control medium or the first heat exchanger is operable as a cooler for the temperature-control medium, so that, for example, heat can be transferred from the temperature-control medium to the coolant via the first heat exchanger. In this way, the temperature-control medium can be cooled and the coolant can be heated. It is conceivable that the coolant circuit and therefore also the first heat exchanger are parts of a climate control device of the motor vehicle, the climate control device of which is also referred to as a climate control system. The climate control device is, for example, a compression cooling unit or is at least operable as a compression cooling unit. Furthermore, it is conceivable that alternatively or additionally the climate control device is operable as a heat pump. In particular, it is conceivable that the first heat exchanger for the coolant is a first evaporator or is operable as a first evaporator, wherein the coolant can be evaporated by means of the first evaporator. By evaporating the coolant, the coolant can particularly advantageously absorb heat, in particular via the first heat exchanger from or out of the temperature-control medium, by which the temperature-control medium, which is also referred to as a temperature control means or temperature control fluid, can advantageously be cooled.

For example, a coolant heat exchanger provided in addition to the first heat exchanger can be arranged in the coolant circuit, which can very particularly be arranged downstream of the first heat exchanger in the coolant circuit.

In a first variant, for example, air can flow around and/or through the coolant heat exchanger, which air can be introduced into the interior, i.e. at least into the section of the interior, and is therefore also referred to as interior air, inside air, or cabin air. For example, heat can be exchanged between the coolant and the cabin air via the coolant heat exchanger, in particular such that heat can pass from or out of the coolant to the cabin air via the coolant heat exchanger. In this way, the coolant is cooled and the cabin air is heated, wherein the interior, i.e. at least parts of the interior, can be warmed or additionally heated in that the cabin air is introduced into the interior.

In a second variant, the coolant heat exchanger can be arranged in an interior circuit, which is also referred to as an inside cycle, inside circuit, or interior cycle. A preferably liquid fluid can flow through the interior circuit, which is, for example, the temperature-control medium or a fluid different from the temperature-control medium. In the second variant, heat can be exchanged between the fluid and the coolant via the coolant heat exchanger, in particular such that heat can pass from or out of the coolant via the coolant heat exchanger to the fluid. In this way, the coolant is cooled and the fluid is heated. It is conceivable here that an interior heat exchanger provided additionally to the first heat exchanger and additionally to the coolant heat exchanger is arranged in the interior circuit, which is also referred to as a heating heat exchanger or is operable as a heating heat exchanger. The fluid can flow through the interior heat exchanger. In addition, for example, the above-mentioned cabin air which can be introduced into the interior can flow around and/or through the interior heat exchanger, wherein heat can be exchanged between the fluid and the cabin air flowing through and/or around the interior heat exchanger via the interior heat exchanger, in particular such that heat can pass from the fluid via the interior heat exchanger to the cabin air. In this way, the fluid is cooled and the cabin air is heated. Since the cabin air can be introduced or is introduced into the interior, the interior can therefore be warmed, i.e. heated. In particular, for example, the coolant heat exchanger can be a condenser or can be operable as a condenser, wherein the coolant can be cooled and in this way condensed by means of the interior heat exchanger, in particular in that heat can pass or passes from the coolant to the cabin air or to the fluid via the coolant heat exchanger. It can be seen that in the first variant and the second variant, in particular in the above-mentioned heat pump mode, the cabin air and therefore the interior can be heated via the first heat exchanger and in particular also via the coolant heat exchanger, wherein in particular the heat pump operation is designed or intended to heat the interior.

Furthermore, a second heat exchanger, which is also arranged in the coolant circuit and is provided in addition to the first heat exchanger, is arranged in the temperature-control circuit, via which heat is exchangeable between the coolant and the temperature-control medium. In particular if the above-mentioned interior heat exchanger is provided, the second heat exchanger is also provided in addition to the interior heat exchanger. The second heat exchanger can be the above-mentioned coolant heat exchanger or a further heat exchanger provided additionally thereto. Heat can be exchanged between the coolant and the temperature-control medium via the second heat exchanger, in particular such that heat can be transferred from the coolant to the temperature-control medium via the second heat exchanger. The coolant can be cooled in this way, so that the second heat exchanger can be designed as a cooler or is operable as a cooler for the coolant. In particular, for example, the coolant can be cooled and thus condensed by means of the second heat exchanger, so that the second heat exchanger can be designed as a condenser or is operable as a condenser.

The temperature-control device comprises a temperature detection device, which is designed to detect, i.e. to measure, a first temperature of the temperature-control medium upstream of the ambient air cooler, a second temperature of the temperature-control medium upstream of the drive machine, a third temperature of the temperature-control medium upstream of the energy storage device, a fourth temperature of the surroundings of the motor vehicle, and a fifth temperature of the electrical energy storage device, wherein the fourth temperature is also referred to as the ambient temperature or outside temperature. For example, the fifth temperature is a temperature of at least one or precisely one of the storage cells. Furthermore, it is conceivable that the fifth temperature represents a temperature of the storage cells, in particular all storage cells, of the electrical energy storage device. For example, the respective temperature detection device comprises a respective temperature sensor for the detection.

The temperature-control device additionally comprises the electronic computing device, which is designed to alternatively operate the temperature-control device in a first heat pump operating mode or a second heat pump operating mode. As explained in more detail hereinafter, the electronic computing device is preferably designed to operate the temperature-control device alternatively in the first heat pump operating mode, the second heat pump operating mode, a third heat pump operating mode, a fourth heat pump operating mode, a fifth heat pump operating mode, or a sixth heat pump operating mode. The heat pump operating modes are different operating modes of the heat pump operation, also referred to simply as modes, so that in the respective heat pump operating mode the temperature-control device is operable or is operated as the above-mentioned heat pump, in order to warm, therefore to heat, at least the section of the motor vehicle in this way, in particular at least the section of the interior of the motor vehicle. As will be explained in more detail hereinafter, the respective heat pump operating mode is also used to control the temperature, i.e. to cool and/or to heat, the electrical energy storage device, by which the electrical energy storage device can be kept in a particularly advantageous temperature range and/or at a particularly advantageous temperature, so that a particularly efficient and effective operation of the electrical energy storage device and therefore of the motor vehicle as a whole can be represented. Because the valve device can be switched into the different switching states, by which the different heat pump operating modes are settable, i.e. activatable, at least the section of the motor vehicle and the electrical energy storage device in particular provided additionally to the section of the motor vehicle can be controlled in temperature particularly as needed and therefore effectively and efficiently. In particular one respective one of the heat pump operating modes, in particular precisely one, is associated with one respective one, in particular precisely one, of the switching states of the valve device, so that by switching the valve device into the respective switching state, the respective heat pump operating mode associated with the respective switching state can be set, i.e. activated, so that as a result the temperature-control device is operable or can be operated in the activated heat pump operating mode.

A method for operating the temperature-control device is also disclosed. In the method, the temperature-control device is alternatively operated in the first heat pump operating mode, in the second heat pump operating mode, in the third heat pump operating mode, in the fourth heat pump operating mode, in the fifth heat pump operating mode, or in the sixth heat pump operating mode. This will be explained in more detail hereinafter.

The electronic computing device is designed to operate the temperature-control device in the first heat pump operating mode when the first temperature is greater than a predetermined first threshold value and the second temperature is greater than a predetermined second threshold value. In other words, in the method, the temperature-control device is operated in the first heat pump operating mode when the first temperature is greater than the first threshold value and the second temperature is greater than the second threshold value. In the first heat pump operating mode, the ambient air cooler, the drive machine, and the first heat exchanger are fluidically connected in series to one another, while a flow of the temperature-control medium through the energy storage device and the second heat exchanger does not take place. This means that in the method, in the first heat pump operating mode, the temperature-control medium flows through the ambient air cooler, the drive machine, and the first heat exchanger in series, i.e. in succession, while the temperature-control medium does not flow through the energy storage device and does not flow through the second heat exchanger.

The electronic computing device is also designed to operate the temperature-control device in the second heat pump operating mode when the second temperature is greater than the first threshold value and less than a third threshold value, which is greater than the first threshold value, and is greater than the ambient temperature. This means that the third threshold value is greater than the first threshold value. In other words, in the method, the temperature-control device is operated in the second heat pump operating mode when the second temperature is greater than the first threshold value and less than the third threshold value and greater than the ambient temperature. In the second heat pump operating mode, the drive machine and the first heat exchanger are fluidically connected in series to one another, and a flow of the temperature-control medium through the ambient air cooler, the energy storage device, and the second heat exchanger does not take place. This means that in the method, in the second heat pump operating mode, the temperature-control medium flows through the drive machine and the first heat exchanger in series, i.e. in succession, while the temperature-control medium does not flow through the ambient air cooler, does not flow through the energy storage device, and does not flow through the second heat exchanger. For example, the temperature-control device comprises a valve device arranged in the temperature-control circuit, by means of which the ambient air cooler, the drive machine, the electrical energy storage device, the first heat exchanger, and the second heat exchanger are interconnectable with one another fluidically, i.e. with respect to a flow of the temperature-control medium through the ambient air cooler, the drive machine, the electrical energy storage device, the first heat exchanger, and the second heat exchanger such that the temperature-control device is alternatively operable in the first heat pump operating mode or in the second heat pump operating mode. The electronic computing device can actuate the valve device for this purpose, for example. The ambient air cooler, the drive machine, the electrical energy storage device, the first heat exchanger, and the second heat exchanger are also referred to as elements. Therefore, the elements can be interconnected with respect to a respective flow of the temperature-control medium through the elements by means of the valve device by actuating the valve device such that the temperature-control device is alternatively operable in the first heat pump operating mode or in the second heat pump operating mode. The valve device can therefore alternatively set the first heat pump operating mode or the second heat pump operating mode by interconnecting the elements. This also applies accordingly for the third heat pump operating mode, the fourth heat pump operating mode, the fifth pump operating mode, and the sixth heat pump operating mode.

To be able to implement a particularly advantageous temperature control, it is provided in one embodiment that the electronic computing device is designed to operate the temperature-control device in the third heat pump operating mode when the third temperature is greater than the fifth temperature and is greater than the ambient temperature and the fifth temperature is less than a predetermined fourth threshold value. In other words, in the method, the temperature-control device is operated in the third heat pump operating mode when the third temperature is greater than the fifth temperature and greater than the ambient temperature, and when the fifth temperature is less than the fourth threshold value. In the third heat pump operating mode, the drive machine, the energy storage device, and the first heat exchanger are fluidically connected in series to one another, in particular by means of the valve device, and in the third heat pump operating mode, a flow of the temperature-control medium through the ambient air cooler does not take place. This means that in the method, in the third heat pump operating mode, the temperature-control medium flows through the drive machine, the energy storage device, and the first heat exchanger in series, while the temperature-control medium does not flow through the ambient air cooler.

To be able to implement a particularly advantageous temperature control, it is provided in one embodiment that the electronic computing device is designed to operate the temperature-control device in the fourth heat pump operating mode when the fifth temperature is greater than the fourth threshold value, the third temperature is greater than the first temperature, less than the third threshold value, and greater than the first threshold value, and the second temperature is greater than the second threshold value. In other words, in the method, the temperature-control device is operated in the fourth heat pump operating mode when the fifth temperature is greater than the fourth threshold value, the third temperature is greater than the first temperature, less than the third threshold value, and greater than the first threshold value, and the second temperature is greater than the second threshold value.

In the fourth heat pump operating mode, the ambient air cooler and the drive machine are fluidically connected in series to one another, in particular by means of the valve device, and are thus arranged in a first circuit strand through which the temperature-control medium flows. In the fourth heat pump operating mode, the energy storage device and the first heat exchanger are fluidically connected in series to one another, in particular by means of the valve device, and are thus arranged in a second circuit strand, through which the temperature-control medium flows and which is fluidically separated from the first circuit strand, while a flow of the temperature-control medium through the second heat exchanger does not take place. This means that in the method, in the fourth heat pump operating mode, the temperature-control medium flows through the first circuit strand and therefore the ambient air cooler in the drive machine in series, and the temperature-control medium flows through the second circuit strand and therefore through the energy storage device and the first heat exchanger in series, wherein the first circuit strand and the second circuit strand are fluidically separated from one another, and the temperature-control medium does not flow through the second heat exchanger.

To be able to implement a particularly advantageous temperature control, it is provided in one embodiment that the electronic computing device is designed to operate the temperature-control device in the fifth pump operating mode when the fifth temperature is greater than the fourth threshold value, the third temperature is greater than the first temperature, less than the third threshold value, and greater than the first threshold value, and the second temperature is less than the second threshold value. In other words, in the method, the temperature-control device is operated in the fifth heat pump operating mode when the fifth temperature is greater than the fourth threshold value, the third temperature is greater than the first temperature, less than the third threshold value, and greater than the first threshold value, and the second temperature is less than the second threshold value.

In the fifth heat pump operating mode, the drive machine is arranged in a drive machine strand through which the temperature-control medium flows, and the energy storage device and the first heat exchanger are fluidically connected in series to one another, in particular by means of the valve device, and are thus arranged in an energy storage device strand, through which the temperature-control medium flows and which is fluidically separated from the drive machine strand, and a flow of the temperature-control medium through the ambient air cooler and the second heat exchanger does not take place. This means that in the method, in the fifth heat pump operating mode, the temperature-control medium flows through the drive machine strand and therefore the drive machine, and the temperature-control medium flows through the energy storage device strand and therefore through the energy storage device and the first heat exchanger in series, wherein the drive machine strand and the energy storage device strand are fluidically separated from one another. In the fifth heat pump operating mode, the temperature-control medium does not flow through the ambient air cooler and does not flow through the second heat exchanger.

To be able to implement a particularly advantageous temperature control, it is provided in one embodiment that the electronic computing device is designed to operate the temperature-control device in the sixth heat pump operating mode when the second temperature is less than the second threshold value and the third temperature is less than the third threshold value and greater than the first threshold value. In other words, in the method, the temperature-control device is operated in the sixth heat pump operating mode when the second temperature is less than the second threshold value and the third temperature is less than the third threshold value and greater than the first threshold value.

In the sixth heat pump operating mode, the drive machine is arranged in the drive machine strand through which the temperature-control medium flows, while the second heat exchanger is arranged in a first heat exchanger strand through which the temperature-control medium flows and a flow of the temperature-control medium through the ambient air cooler does not take place. In the sixth heat pump operating mode, the energy storage device and the first heat exchanger are arranged in a second heat exchanger strand through which the temperature-control medium flows and are connected in series to one another, wherein the second heat exchanger strand is fluidically separated from the drive machine strand and the first heat exchanger strand. This means that in the method, in the sixth heat pump operating mode, the temperature-control medium flows through the drive machine strand and therefore the drive machine, while the temperature-control medium flows, in particular in parallel, through the first heat exchanger strand and therefore the second heat exchanger, and the temperature-control medium flows through the second heat exchanger strand and therefore through the first heat exchanger and through the energy storage device, in particular in series, while the temperature-control medium does not flow through the ambient air cooler.

A second aspect of the disclosure relates to a motor vehicle, also referred to simply as a vehicle and preferably designed as a car, in particular as a passenger vehicle, which comprises a temperature-control device according to the first aspect of the disclosure. Advantages and advantageous embodiments of the first aspect of the disclosure are to be viewed as advantages and advantageous embodiments of the second aspect of the disclosure and vice versa.

For example, the temperature-control medium comprises a first strand, through which the temperature-control medium can flow and in which the ambient air cooler is arranged. The temperature-control medium can flow through the first strand and therefore the ambient air cooler, so that heat is exchangeable via the ambient air cooler between the temperature-control medium flowing through the ambient air cooler and the air flowing around the ambient air cooler, which is also referred to as ambient air, in particular such that heat can pass from the temperature-control medium to the ambient air via the ambient air cooler. The temperature-control medium can be cooled in this way.

The temperature-control circuit additionally comprises a second strand, for example, in which the drive machine is arranged, by means of which the motor vehicle can be driven. Therefore, the temperature-control medium can flow through the second strand and therefore the at least one drive machine, so that the at least one drive machine can be controlled in temperature, i.e. cooled or possibly heated, by means of the temperature-control medium. For example, heat can be exchanged between the drive machine and the temperature-control medium flowing through the second strand and therefore the drive machine, in particular such that alternatively heat can pass from the temperature-control medium to the drive machine or heat can pass from the drive machine to the temperature-control medium, so that the drive machine is alternatively heated or cooled. For example, if the temperature-control medium has a higher temperature than the drive machine on its path through the second strand, the temperature-control medium is or functions as a heating medium, by means of which the drive machine can be heated. If the temperature-control medium has, for example, a lower temperature than the drive machine on its path through the second strand, heat can thus pass from the drive machine to the temperature-control medium, by which the drive machine can be cooled. The temperature-control medium is preferably part of the temperature-control device.

The temperature-control circuit additionally comprises, for example, a third strand through which the temperature-control medium can flow, and which comprises a first branch and a second branch. The electrical energy storage device is arranged in the first branch. The second branch of the third strand is a bypass branch, which is also referred to as a bypass, bypass line, or detour line. The temperature-control medium can bypass the first branch and therefore the first electrical energy storage device via the bypass branch. This means that the temperature-control medium flowing through the second branch bypasses the first branch and therefore the electrical energy storage device, thus does not flow through the first branch and thus does not flow through the electrical energy storage device.

The temperature-control circuit furthermore comprises, for example, a fourth branch through which the temperature-control medium can flow, and in which the first heat exchanger provided in particular additionally to the ambient air cooler is arranged. The first heat exchanger is arranged in the fourth strand and therefore in the temperature-control circuit, and in addition the first heat exchanger is arranged in the coolant circuit through which a coolant can flow.

The temperature-control circuit also comprises, for example, a fifth strand through which the temperature-control medium can flow, and in which the second heat exchanger provided in addition to the first heat exchanger is arranged. The second heat exchanger is arranged in the fifth strand and therefore in the temperature-control circuit and also in the coolant circuit.

The strands of the temperature-control circuit are, for example, respective longitudinal areas of the temperature-control circuit through which the temperature-control medium can flow, wherein in particular the above-mentioned interior circuit is provided in addition to the strands of the temperature-control circuit. In particular, in the mentioned second variant, the coolant heat exchanger can be arranged in the interior circuit provided in addition to the strands of the temperature-control circuit, which is also referred to as an inside cycle, inside circuit, or interior cycle.

The temperature-control device comprises the temperature detection device, which is designed, for example, to detect, i.e. to measure, the first temperature of the temperature-control medium in the first strand upstream of the ambient air cooler. For example, a conveyor device is arranged in the temperature-control circuit, by means of which, for example, the temperature-control medium can be conveyed through the temperature-control circuit, in particular in a direction of flow. With respect to the direction of flow, i.e. with respect to the temperature-control medium flowing away from the conveyor device and flowing with respect to the ambient air cooler, the first temperature of the temperature-control medium is a temperature of the temperature-control medium prevailing downstream of the conveyor device and upstream of the ambient air cooler in the first strand. The temperature detection device is also designed, for example, to detect, i.e. to measure, the second temperature of the temperature-control medium in the second strand upstream of the drive machine and in particular downstream of the conveyor device. The temperature detection device is also designed, for example, to detect, i.e. to measure the third temperature of the temperature-control medium in the third strand upstream of the first branch and upstream of the second branch and in particular downstream of the conveyor device. This means that the second temperature of the temperature-control medium prevails, for example, in the fifth strand upstream of the drive machine and in particular downstream of the conveyor device, and the third temperature of the temperature-control medium prevails, for example, in the third strand upstream of the first branch, upstream of the second branch, and downstream of the conveyor device. In particular, the above-mentioned terms “upstream” and “downstream” refer to the mentioned direction of flow, i.e. to the temperature-control medium flowing away from the conveyor device and flowing toward the ambient air cooler or the drive machine or to the temperature-control medium flowing through the third strand.

The temperature detection device is also designed, for example, to detect, i.e. to measure, the fourth temperature of the above-mentioned surroundings of the motor vehicle. Furthermore, the temperature detection device is designed, for example, to detect the fifth temperature of the electrical energy storage device. Therefore, for example, a first temperature sensor for detecting the first temperature is arranged in the first strand upstream of the ambient air cooler and in particular downstream of the conveyor device. For example, a second temperature sensor for detecting the second temperature is arranged in the fifth strand upstream of the drive machine and very particularly downstream of the conveyor device. Furthermore, for example, a third temperature sensor for detecting, i.e. for measuring, the third temperature is arranged in the third strand upstream of the first branch and upstream of the second branch and very particularly downstream of the conveyor device. A fourth temperature sensor is, for example, an ambient temperature sensor, by means of which the fourth temperature, therefore the ambient temperature, can be detected. A fifth temperature sensor for detecting the fifth temperature is arranged, for example, in the electrical energy storage device.

The temperature-control device additionally comprises the valve device, by means of which the strands of the temperature-control circuit can be interconnected with one another. For this purpose, for example, the valve device is switchable into different switching states, in particular by actuating the valve device, wherein the strands are interconnected with one another in the switching states by means of the valve device. The switching states differ from one another here, for example, in their interconnections of the strands. For example, the valve device can be electrically or electronically actuated. For example, the valve device comprises an electronic computing device, also referred to as a control unit, which can provide, for example, an actuation signal, in particular an electrical actuation signal. The valve device can receive the one control signal, for example, by which the valve device is actuated or can be actuated. The electronic computing device can therefore actuate the valve device and therefore switch it between the switching states, therefore switch it back and forth. In particular, the valve device is electrically operable, so that, for example, the valve device can be switched, i.e. switch back and forth, between the switching states by supplying the valve device with electrical energy.

The electronic computing device is designed to operate the temperature-control device in the first heat pump operating mode when the first temperature is greater than a predetermined first threshold value and the second temperature is greater than a predetermined second threshold value. In other words, in the method, the temperature-control device is operated in the first heat pump operating mode when the first temperature is greater than the first threshold value and the second temperature is greater than the second threshold value. In the first heat pump operating mode, the strands of the temperature-control circuit are interconnected with one another by means of the valve device such that the first strand, the second strand, and the fourth strand are fluidically connected in series to one another and thus form an overall strand through which the temperature-control medium flows. This means that in the first heat pump operating mode, the temperature-control medium flows through the first overall strand, in particular in that the temperature-control medium is conveyed through the first overall strand by means of the conveyor device. In the first heat pump operating mode, the strands of the temperature-control circuit are interconnected with one another by means of the temperature-control device such that a flow of the temperature-control medium through the third strand and the fifth strand does not take place. In other words, although, for example, the temperature-control medium is conveyed through the first overall strand by means of the conveyor device, so that the temperature-control medium flows through the first overall strand, the temperature-control medium does not flow through the third strand and also does not flow through the fifth strand, since this is prevented, for example, by means of the valve device.

The electronic computing device is designed to operate the temperature-control device in the second heat pump operating mode when the second temperature is greater than the first threshold value and less than a third threshold value, which is greater than the first threshold value, and is greater than the ambient temperature. In other words, in the method, the temperature-control device is operated in the second heat pump operating mode when the second temperature is greater than the first threshold value and less than the third threshold value and greater than the ambient temperature, wherein the third threshold value is greater than the first threshold value. In the second heat pump operating mode, the strands of the temperature-control circuit are interconnected with one another by means of the valve device such that the second strand and the fourth strand are fluidically connected in series to one another and thus form a second overall strand through which the temperature-control medium flows. This means that in the second heat pump operating mode, the temperature-control medium flows through the second overall strand, for example, in that in the second heat pump operating mode in the method, the temperature-control medium is conveyed through the second overall strand by means of the conveyor device. In the second heat pump operating mode, a flow of the temperature-control medium through the first strand, the third strand, and the fifth strand does not take place. In other words, although the temperature-control medium flows through the second overall strand in the second heat pump operating mode, in particular in that in the method and in the second heat pump operating mode the conveyor device conveys the temperature-control medium through the second overall strand, the temperature-control medium does not flow through the first strand, does not flow through the third strand, and does not flow through the fifth strand, since this is prevented, for example, by means of the valve device.

The electronic computing device is designed to operate the temperature-control device in the third heat pump operating mode when the third temperature is greater than the fifth temperature and greater than the ambient temperature and the fifth temperature is less than a predetermined fourth threshold value, wherein in the third heat pump operating mode, the strands are interconnected by means of the valve device such that the second strand, the third strand, and the fourth strand are connected in series to one another and thus form a third overall strand through which the temperature-control medium flows, and in the third heat pump operating mode, a flow of the temperature-control medium does not take place through the first strand and the fifth strand. This means that although the temperature-control medium flows through the third overall strand, for example, in that the conveyor device conveys the temperature-control medium through the third overall strand, the temperature-control medium does not flow through the first strand and also does not flow through the fifth strand, since this is prevented, for example, by means of the valve device.

The electronic computing device is designed to operate the temperature-control device in the fourth heat pump operating mode when the fifth temperature is greater than the fourth threshold value, the third temperature is greater than the first temperature, less than the third threshold value, and greater than the first threshold value, and the second temperature is greater than the second threshold value. In other words, in the method and in particular by means of the electronic computing device, the temperature-control device is operated in the fourth heat pump operating mode when the fifth temperature is greater than the fourth threshold value, when the third temperature is greater than the first temperature, less than the third threshold value, and greater than the first threshold value, and when the second temperature is greater than the second threshold value. In the fourth heat pump operating modes, the strands of the temperature-control circuit are interconnected with one another by means of the valve device such that the first strand and the second strand are fluidically connected in series to one another and thus form a fourth overall strand through which the temperature-control medium flows. This means that in the method, in the fourth heat pump operating mode, the temperature-control medium flows through the fourth overall strand, in particular in that the temperature-control medium is conveyed through the fourth overall strand in the fourth heat pump operating mode. In particular, the fourth overall strand is the above-mentioned first circuit strand.

In the fourth heat pump operating mode, the third strand and the fourth strand form a fifth overall strand through which the temperature-control medium flows, and which is fluidically separated from the fourth overall strand. This means that in the method, in the fourth heat pump operating mode, the temperature-control medium (also) flows through the fifth overall strand, for example, in that in the fourth heat pump operating mode, the temperature-control medium is conveyed by means of the conveyor device through the fifth overall strand. In this case, however, the fifth overall strand and the fourth overall strand are fluidically separated from one another by means of the valve device, so that the temperature-control medium flowing through the fourth overall strand does not flow through the fifth overall strand, and so that the temperature-control medium flowing through the fifth overall strand does not flow through the fourth overall strand. In particular, the fifth overall strand is the above-mentioned second circuit strand.

In addition, in the fourth heat pump operating mode, the strands of the temperature-control circuit are interconnected with one another by means of the valve device such that in the fourth heat pump operating mode, a flow of the temperature-control medium through the fifth strand does not take place. This means that although, in the fourth heat pump operating mode, the temperature-control medium flows through the fourth overall strand and through the fifth overall strand, for example, in that the temperature-control medium is conveyed through the fourth overall strand and through the fifth overall strand by means of the conveyor device, the temperature-control medium does not flow through the fifth strand in the fourth heat pump operating mode, since this is prevented, for example, by means of the valve device.

Furthermore, the electronic computing device is designed to operate the temperature-control device in the fifth heat pump operating mode when the fifth temperature is greater than the fourth threshold value, the third temperature is greater than the first temperature, less than the third threshold value, and greater than the first threshold value, and the second temperature is less than the second threshold value. In other words, for example, in the method, the temperature-control device is in particular operated by means of the electronic computing device in the fifth heat pump operating mode when the fifth temperature is greater than the fourth threshold value, when the third temperature is greater than the first temperature, less than the third threshold value, and greater than the first threshold value, and when the second temperature is less than the second threshold value. In the fifth heat pump operating mode, the strands of the temperature-control circuit are interconnected with one another by means of the valve device such that the second strand forms a sixth overall strand through which the temperature-control medium flows. This means that in the method, in the fifth heat pump operating mode, the temperature-control medium flows through the sixth overall strand and therefore the second strand, for example, in that in the method and in the fifth heat pump operating mode, the temperature-control medium is conveyed by means of the conveyor device through the sixth overall strand. In particular, in the fifth heat pump operating mode, the sixth overall strand is the above-mentioned drive machine strand.

In the fifth heat pump operating mode, the strands of the temperature-control circuit are interconnected with one another by means of the valve device such that the third strand and the fourth strand form a seventh overall strand through which the temperature-control medium flows, and which is fluidically separated from the sixth overall strand. This means that in the method, in the fifth pump operating mode, the temperature-control medium flows through the seventh overall strand, therefore flows through the seventh overall strand, for example, in that in the method, in the fifth heat pump operating mode, the temperature-control medium is conveyed through the seventh overall strand by means of the conveyor device. In this case, the sixth overall strand and the seventh overall strand are fluidically separated from one another, however, so that the temperature-control medium flowing through the sixth overall strand does not flow through the seventh overall strand and the temperature-control medium flowing through the seventh overall strand does not flow through the sixth overall strand. In addition, in the fifth heat pump operating mode, the strands of the temperature-control circuit are interconnected with one another by means of the valve device such that a flow of the temperature-control medium through the first strand and the fifth strand does not take place. This means that although in the fifth heat pump operating mode, the temperature-control medium flows through the sixth overall strand and through the seventh overall strand, in particular in that the temperature-control medium is conveyed by means of the conveyor device through the sixth overall strand and through the seventh overall strand, the temperature-control medium does not flow through the first strand and also does not flow through the fifth strand, since this is prevented, for example, by means of the valve device. In particular, in the fifth heat pump operating mode, the seventh overall strand is the above-mentioned energy storage device strand.

For example, both the interior of the motor vehicle and the electrical energy storage device can be controlled in temperature as needed and therefore particularly advantageously by the switching as needed of the valve device between the switching states and the resulting activation of the respective heat pump operating mode, by which, for example, the energy storage device can be kept in the above-mentioned temperature range. Particularly efficient operation of the motor vehicle can be ensured in this way. In particular, the disclosure enables excessively high temperatures of the energy storage device and excessively low temperatures of the energy storage device to be avoided, wherein at the same time unfavorable and, for example, both excessively high temperatures and excessively low temperatures can be avoided in the interior. Effective and efficient operation of the energy storage device can thus be ensured, on the one hand, and in the interior, particularly comfortable conditions can be created or maintained for persons located in the interior, on the other hand.

Heat provided by the drive machine and heat from the surroundings can be used, for example, by the or in the first heat pump operating mode in order to heat the cabin air and therefore the interior, in particular via the first heat exchanger and the coolant heat exchanger. Heat from the electrical energy storage device is, for example, not used or is not available for this purpose. Heat only provided by the electrical machine with respect to the surroundings, the drive machine, and the electrical energy storage device, i.e. waste heat, can be used, for example, in the or by the second heat pump operating mode, in order to heat the cabin air and as a result the interior, in particular as described above and in this case in particular via the coolant heat exchanger. In particular heat provided only by the drive machine with respect to the surroundings and the drive machine, i.e. waste heat, can be used, for example, in the or by the third heat pump operating mode in order to heat the cabin air and therefore the interior via the first heat exchanger and in this case in particular via the coolant heat exchanger, and the remaining heat provided by the drive machine can be used to heat, i.e. to heat up, the electrical energy storage device. Heat provided only by the electrical energy storage device with respect to the surroundings, the drive machine, and the electrical energy storage device, i.e. waste heat, can be used in the or by the fourth heat pump operating mode, for example, in order to heat, i.e. heat up, the cabin air and therefore the interior, in particular via the first heat exchanger (chiller) and, for example, also via the coolant heat exchanger. Any heat which is or can be provided by the drive machine, i.e. waste heat, can be discharged to the surroundings, for example, via the ambient air cooler, by which the drive machine can be cooled. Heat exclusively provided by the electrical energy storage device with respect to the surroundings, the electrical energy storage device, and the drive machine, therefore waste heat, can be used in the or by the fifth pump operating mode, for example, in order to heat, i.e. heat up, the cabin air and therefore the interior, in particular via the first heat exchanger and very particularly also via the coolant heat exchanger. In this case, the temperature-control medium flowing through the second strand and therefore the drive machine does not flow through the ambient air cooler, but rather avoids, i.e. bypasses it, in particular via a detour line, also referred to as a bypass line, bypassing the ambient air cooler, by which an advantageous temperature control of the drive machine can also be ensured. The disclosure is or offers an advantageous operating strategy, according to which the electrical energy storage device can be controlled in temperature efficiently, in order to thereby, for example, bring an energy storage device into the above-mentioned temperature range or to an advantageous temperature, in order to then keep it in the temperature range or at the temperature, wherein an advantageous temperature control of the interior can be ensured at the same time.

To be able to implement a particularly advantageous temperature control, it is provided in one embodiment of the disclosure that in the third heat pump operating mode, the temperature-control medium flows through the first branch and the second branch is fluidically blocked by means of the valve device. This means that in the method, in the third heat pump operating mode, the temperature-control medium flows through the first branch and therefore through the energy storage device and does not flow through the second branch, i.e. does not bypass the electrical energy storage device.

A further embodiment is distinguished in that, in the fourth heat pump operating mode, the temperature-control medium flows through the first branch and the second branch is fluidically blocked by means of the valve device, by which a particularly advantageous temperature control can be represented.

In a further particularly advantageous embodiment of the disclosure, it is provided that, in the fifth pump operating mode, the temperature-control medium flows through the first branch and the second branch is fluidically blocked by means of the valve device, by which a particularly advantageous temperature control, in particular of the electrical energy storage device, can be ensured.

In a further particularly advantageous embodiment of the disclosure, the electronic computing device is also designed to operate the temperature-control device in the sixth heat pump operating mode when the second temperature is less than the second threshold value and the third temperature is less than the third threshold value and greater than the first threshold value. It is therefore provided in the method, for example, that the temperature-control device is operated, in particular by means of the electronic computing device, in the sixth heat pump operating mode when the second temperature is less than the second threshold value, and when the third temperature is less than the third threshold value and greater than the first threshold value. In the sixth heat pump operating mode, the strands of the temperature-control circuit are interconnected with one another by means of the valve device such that the second strand forms an eighth overall strand through which the temperature-control medium flows. It is therefore provided, for example, in the method, in the sixth heat pump operating mode, that in the sixth heat pump operating mode the temperature-control medium flows through the eighth overall strand and therefore the second strand, for example, in that the temperature-control medium is conveyed through the eighth overall strand by means of the conveyor device. In particular, in the sixth heat pump operating mode, the eighth overall strand is the above-mentioned drive machine strand.

In the sixth heat pump operating mode, the strands of the temperature-control circuit are interconnected with one another by means of the temperature-control device such that the temperature-control medium flows through the fifth end face, so that in the method, in the sixth heat pump operating mode, the temperature-control medium flows through the fifth end face, for example, in that in the method, in the sixth heat pump operating mode, the temperature-control medium is conveyed through the fifth end face by means of the conveyor device. In the sixth heat pump operating mode, the fifth strand branches off at a branching point from the eighth overall strand, wherein the branching point is arranged in the flow direction of the temperature-control medium flowing through the eighth overall strand upstream of the drive machine and downstream of a measuring point at which the second temperature is detectable or is detected, so that, for example, at the mentioned measuring point, the second temperature sensor is arranged in particular in the eighth overall strand and therefore in the temperature-control circuit. In particular, in the sixth heat pump operating mode, the fifth strand is the above-mentioned first heat exchanger strand.

In the sixth heat pump operating mode, the fifth strand discharges into the eighth overall strand at a discharge point, which is arranged downstream of the drive machine and upstream of the measuring point in the direction of flow of the temperature-control medium flowing through the eighth overall strand. The temperature-control medium flowing through the fifth strand therefore flows from the branching point to the discharge point, so that the discharge point is arranged downstream of the branching point in the direction of flow of the temperature-control medium flowing through the fifth strand. In the sixth heat pump operating mode, the strands of the temperature-control circuit are interconnected with one another by means of the valve device such that in the sixth heat pump operating mode, a flow of the temperature-control medium through the first strand does not take place. This means that, in particular in the method, the temperature-control medium flows in the sixth heat pump operating mode through the fifth strand and through the eighth overall strand, in particular in that the temperature-control medium is conveyed through the fifth strand and through the eighth overall strand by means of the conveyor device, but in the sixth heat pump operating mode, the temperature-control medium does not flow through the first strand, since this is prevented, for example, by means of the valve device. In addition, in the sixth heat pump operating mode, the strands of the temperature-control circuit are interconnected with one another by means of the valve device such that the third strand and the fourth strand form a ninth overall strand through which the temperature-control medium flows, and which is fluidically separated from the eighth overall strand and from the fifth strand. This means that in the method, in the sixth heat pump operating mode, the temperature-control medium flows through the ninth overall strand, for example, in that in the sixth heat pump operating mode, the temperature-control medium is conveyed through the ninth overall strand by means of the conveyor device. In particular, in the sixth heat pump operating mode, the ninth overall strand is the above-mentioned second heat exchanger strand. However, the ninth overall strand is fluidically separated, in particular by means of the valve device, from the eighth overall strand and from the fifth strand, so that the temperature-control medium flowing through the eighth overall strand does not flow through the ninth overall strand, the temperature-control medium flowing through the fifth strand does not flow through the ninth overall strand, the temperature-control medium flowing through the ninth overall strand does not flow through the eighth overall strand, and the temperature-control medium flowing through the ninth overall strand does not flow through the fifth strand. A particularly advantageous and needs-based temperature control can be ensured in this way. For example, heat only provided by the surroundings with respect to the electrical energy storage device, the drive machine, and the surroundings or heat only from the surroundings can be used in the or by the sixth heat pump operating mode to heat the cabin, in particular the interior. For this purpose, for example, a second ambient air cooler provided additionally to the ambient air cooler, which is also referred to as the first ambient air cooler, is provided, which, for example, in the sixth heat pump operating mode is arranged in the fourth strand or is preferably fluidically connected in series to the fourth strand and is therefore part of the ninth overall strand. The preceding and following statements on the first ambient air cooler can also be readily transferred to the second ambient air cooler and vice versa. Air in and/or from the surroundings can therefore flow around the second ambient air cooler. For example, heat from the air or the ambient air can be transferred to the temperature-control medium flowing through the ninth overall strand via the second ambient air cooler. Heat can be transferred from the temperature-control medium to the coolant via the first heat exchanger, so that, for example, heat can be transferred from the coolant to the cabin air in particular via the coolant heat exchanger and possibly via the above-mentioned interior heat exchanger. It is conceivable that in the sixth heat pump operating mode, the temperature-control medium flowing through the second strand or the eighth overall strand and therefore the drive machine detours, therefore bypasses, both the first ambient air cooler and the second ambient air cooler, and which can also ensure an advantageous temperature control of the drive machine.

In order to be able to implement a particularly advantageous temperature control, it is provided in a further embodiment of the disclosure that in the sixth heat pump operating mode, the temperature-control medium flows through the second branch and the first branch is fluidically blocked by means of the valve device, so that in particular in the method, in the sixth heat pump operating mode, the temperature-control medium flows through the second branch and therefore bypasses the electrical energy storage device via the second branch and therefore does not flow through the electrical energy storage device. The electrical energy storage device can also advantageously be controlled in temperature in this way.

In a further particularly advantageous embodiment of the disclosure, the second strand comprises a third branch, in which the drive machine is arranged as the first drive machine. The second strand comprises a fourth branch fluidically connected in parallel to the third branch, in which a second drive machine provided additionally to the first drive machine for driving the motor vehicle is arranged. The preceding and following statements on the first drive machine can be readily transferred to the second drive machine and vice versa. A particularly efficient operation of the motor vehicle can be represented in this way.

In order to be able to implement a particularly effective, efficient, and needs-based temperature control, it is provided in a further embodiment of the disclosure that an electrical heating element for heating the temperature-control medium is arranged in the fourth strand. This means that by means of the electrical heating element, the temperature-control medium which flows through the fourth strand can be heated using electrical energy with which the heating element is supplied, so that a needs-based heating of the temperature-control medium in the fourth strand can be represented. It is preferably provided that with respect to the temperature-control medium flowing through the fourth strand and in this case flowing away from the conveyor device and toward the first heat exchanger, the electrical heating element is arranged downstream of the conveyor device and upstream of the first heat exchanger (chiller). Particularly effective and efficient temperature control can be ensured in this way.

Finally, it has proven to be particularly advantageous if the conveyor device comprises a first pump arranged in the second strand for conveying the temperature-control medium and a second pump arranged in the third strand for conveying the temperature-control medium. In this way, a needs-based and effective and efficient temperature control can be implemented and preferably the respective pump is a respective electric pump, therefore is electrically operable.

In particular, at least the following advantages can be implemented by the disclosure:
reducing heat losses in comparison to conventional solutions
absorbing heat from the surroundings
increasing the storage device or cell temperatures by needs-based heat flow guidance
increasing the temperature of the drive machine by heat flow guidance
potentially increasing the storage device or cell temperatures, in particular during a renewed startup
higher availability of recuperation and drive power
higher efficiency of energy provision by the electrical energy storage device
avoiding a storage device heating unit by using waste heat of the drive machine
by using residual heat of the electrical energy storage device, the drive machine, and the surroundings for the heat pump
temperature tracking of the electrical energy storage device via the heat pump operating modes, also referred to as heat pump operating styles, with the goal of efficiently reaching the temperature range also referred to as the target corridor and keeping the electrical energy storage device or its temperature in the target corridor
heat pump operation or use of heat via the drive machine and the electrical energy storage device and thus implementation of a heat supply
heat pump operation and therefore use of heat via the electrical energy storage device and therefore heat dissipation
advantageous strategy for efficient guidance of existing heat flows
no active control efforts, for example, in the case of additional heating

Further details of the disclosure result from the following description of a preferred exemplary embodiment with the associated drawings. In the figures:

### BRIEF DESCRIPTION OF THE DRAWINGS

FIG. 1 is a schematic representation of a temperature-control device for a motor vehicle, wherein a first heat pump operating mode of the temperature-control device is illustrated in FIG. 1;

FIG. 2 is a schematic representation of the temperature-control device, wherein a second heat pump operating mode of the temperature-control device is illustrated;

FIG. 3 is a schematic representation of the temperature-control device, wherein a third heat pump operating mode of the temperature-control device is illustrated;

FIG. 4 is a schematic representation of the temperature-control device, wherein a fourth heat pump operating mode of the temperature-control device is illustrated;

FIG. 5 is a schematic representation of the temperature-control device, wherein a fifth heat pump operating mode of the temperature-control device is illustrated;

FIG. 6 is a schematic representation of the temperature-control device, wherein a sixth heat pump operating mode of the temperature-control device is illustrated; and

FIG. 7 is a schematic representation of the temperature-control device, wherein a seventh operating mode of the temperature-control device is illustrated.

### DETAILED DESCRIPTION OF THE DRAWINGS

In the figures, identical or functionally-identical elements are provided with identical reference signs.

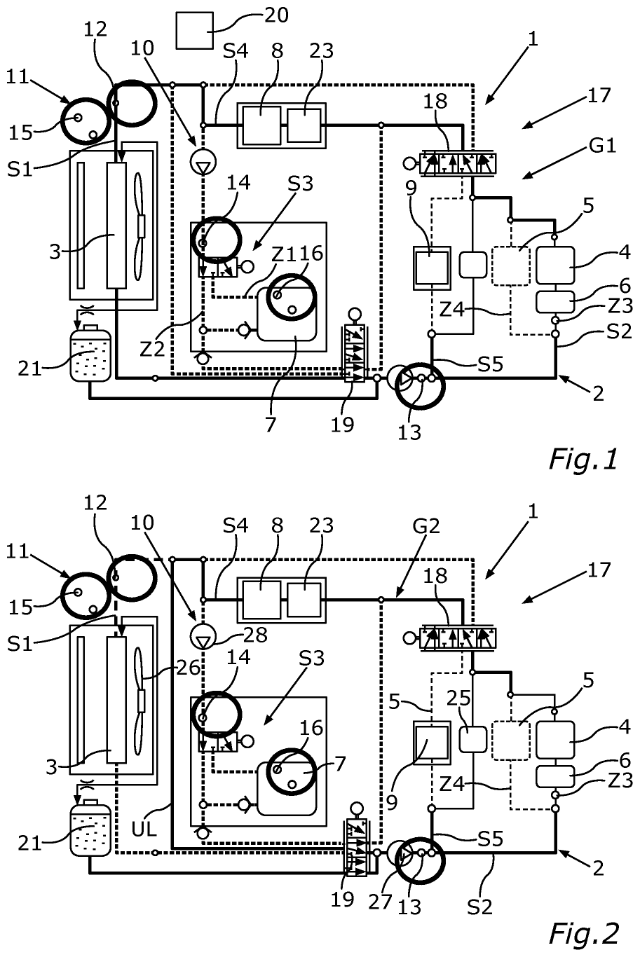

FIG. 1 shows a schematic representation of a temperature-control device 1 of a motor vehicle, also referred to simply as a vehicle and preferably designed as a car, in particular as a passenger vehicle. The temperature-control device 1 comprises a temperature-control circuit 2, through which a preferably liquid temperature-control medium, which is preferably part of the temperature-control device 1, can flow, and which is also simply referred to as a temperature control cycle, cycle, or circuit. The temperature-control circuit 2 comprises a first strand S1 through which the temperature-control medium can flow and in which a first ambient air cooler 3 is arranged. Ambient air, therefore air located in the surroundings of the motor vehicle, can flow around the ambient air cooler 3, so that heat can pass from the temperature-control medium to the ambient air via the ambient air cooler 3. The temperature-control medium can be cooled via the ambient air cooler 3 in this way. The temperature-control circuit 2 additionally comprises a second strand S2, through which the temperature-control medium can flow and in which, as will be explained in more detail hereinafter, two drive machines 4 and 5 are arranged. In the exemplary embodiment shown in the figures, the respective drive machine 4, 5 is designed as a respective electric machine, by means of which the motor vehicle can be electrically driven, in particular driven solely electrically. For example, at least one electrical or electronic first component 6 is also arranged in the strand S2, which is, for example, a power electronics unit assigned in particular to the drive machine 4.

The temperature-control circuit 2 additionally comprises a third strand S3, through which the temperature-control medium can flow and which comprises a first branch Z1 and a second branch Z2 as a bypass branch. An electrical energy storage device 7 is arranged in the first branch Z1, which is preferably a high voltage component and is therefore also referred to as an HVS or high-voltage storage device. The temperature-control medium can bypass the first branch via the second branch Z2, so that the temperature-control medium flowing through the second branch Z2 does not flow through the first branch Z1 and therefore does not flow through the electrical energy storage device 1, which is also simply referred to as a storage device or energy storage device. It can be seen from FIG. 1 that the second strand S2 comprises a third branch Z3, in which the drive machine 4 and in the present case also the component 6 are arranged. In addition, the second strand S2 comprises a fourth branch Z4, in which the drive machine 5 is arranged. In particular at least when the temperature-control medium flows through the second strand S2 and in this case through the branches Z3 and Z4, the branches Z3 and Z4 are fluidically connected in parallel to one another.

The temperature-control circuit 2 additionally comprises a fourth strand S4, in which a first heat exchanger 8 is arranged. The first heat exchanger 8 is also referred to as a chiller. The first heat exchanger 8 is also arranged in a coolant circuit (not shown in the figures), through which a coolant can flow and which is preferably arranged additionally to the temperature-control circuit 2 and is very preferably fluidically separated from the temperature-control circuit 2. Heat can be exchanged between the coolant and the temperature-control medium via the heat exchanger 8, in particular such that the heat exchanger 8 functions, is designed, or is operable as a cooler for the temperature-control medium. Therefore, for example, heat can pass from the temperature-control medium to the coolant via the heat exchanger 8, by which the temperature-control medium is cooled and the coolant is heated.

The temperature-control circuit 2 additionally comprises a fifth strand S5, in which a second heat exchanger 9 is arranged. The heat exchanger 9 is also arranged in the coolant circuit through which the coolant can flow. In particular, the second heat exchanger 9 can be designed, function, or be operable as a cooler for the coolant, so that, for example, the coolant can be cooled by means of the heat exchanger 9. In particular, for example, the heat exchanger 9 is a condenser or is operable as a condenser, so that the coolant can be cooled and thus condensed by means of the heat exchanger 9. Heat can be exchanged between the temperature-control medium flowing through the strand S5 in particular and the coolant via the heat exchanger 9, in particular such that heat can pass via the heat exchanger 9 from the coolant to the temperature-control medium flowing through the strand S5 in particular. Since in particular the temperature-control medium is a liquid, therefore, for example, the heat exchanger 9 is designed as a liquid-cooled, in particular as a water-cooled condenser, which is also designated by WCC.

The temperature-control device 1 comprises a conveyor device 10 arranged in the temperature-control circuit 2, by means of which the temperature-control medium can be conveyed, in particular in a flow direction, through the temperature-control circuit. Preferably, the conveyor device 10 is electrically operable. The conveyor device 10 will be explained in more detail hereinafter. Furthermore, the temperature-control device 1 comprises a temperature detection device 11 arranged in particular in the temperature-control circuit 2, by means of which a first temperature of the temperature-control medium, also designated by T3, can be detected, i.e. measured, in the first strand S1 upstream of the ambient air cooler 3 and downstream of the conveyor device 10. For this purpose, for example, the temperature detection device 11 comprises a first temperature sensor 12, which is arranged at a first measuring point in the temperature-control circuit 2, wherein the first measuring point is arranged in the strand S1 upstream of the ambient air cooler 3 and in particular downstream of the conveyor device 10. The first temperature sensor 12 can measure the first temperature (T3) at the first measuring point, so that the first temperature prevails at the first measuring point and is a first temperature of the temperature-control medium in the temperature-control circuit 2 at the measuring point. By means of the temperature detection device 11, a second temperature of the temperature-control medium can be detected, i.e. measured, in the second strand upstream of the drive machines 4 and 5. For this purpose, for example, the temperature detection device 11 comprises a second temperature sensor 13, which is arranged at a second measuring point in the temperature-control circuit 2, in particular in the strand S2. The second temperature sensor 13 can detect, i.e. measure, the second temperature, which is also designated by T5, at the second measuring point, wherein in the present case the second measuring point and therefore, for example, the second temperature sensor 13 are arranged upstream of the drive machines 4 and 5 and in particular downstream of the conveyor device 10. In the exemplary embodiment shown in the figures, the second measuring point and therefore the second temperature sensor 13 is arranged in the direction of flow of the temperature-control medium flowing through the second strand S2 and in this case flowing away from the conveyor device 10 and toward the respective drive machine 4, 5, for example, upstream of the strand S5, in particular is arranged upstream of the branching point at which, for example, the strand S5 branches off from the strand S2.

The temperature detection device 11 can detect, i.e. measure, a third temperature of the temperature-control medium in the third strand S3 upstream of the first branch Z1 and upstream of the second branch Z2 and preferably downstream of the conveyor device 10. For this purpose, for example, the temperature detection device 11 comprises a third temperature sensor 14, which is arranged at a third measuring point in the temperature-control circuit 2. Therefore, for example, the temperature sensor 14 can detect the third temperature of the temperature-control medium at the third measuring point, so that the third temperature is a third temperature of the temperature-control medium prevailing at the third measuring point. Accordingly, the second temperature is a second temperature of the temperature-control medium prevailing at the second measuring point. In this case, the second temperature, the third temperature, and the first temperature prevail in the temperature-control circuit 2. The third measuring point is arranged in the direction of flow of the temperature-control medium flowing through the strand S3 and in this case flowing away from the conveyor device 10 and toward the branches Z1 and Z2 upstream of the branches Z1 and Z2 and downstream of the conveyor device 10. The third temperature is also designated by T6. The temperature detection device 11 can additionally detect an ambient temperature as a fourth temperature. The fourth temperature is therefore a temperature of the above-mentioned surroundings of the motor vehicle. For this purpose, for example, the temperature detection device 11 comprises a fourth temperature sensor 15, which is also referred to as an ambient temperature sensor. The ambient temperature can be detected, i.e. measured, by means of the ambient temperature sensor. Finally, the temperature detection device 11 can detect, i.e. measure, a temperature of the electrical energy storage device 7 also designated by Tz. For this purpose, the temperature detection device 11 comprises a fifth temperature sensor 16, which is arranged, for example, in the electrical energy storage device 7. For example, the fifth temperature is or represents a temperature of at least one storage cell of the electrical energy storage device 7.

The temperature-control device 1 comprises a valve device 17, which comprises two valves 18 and 19 in the present case. For example, the valve 18 is a component arranged externally with respect to the valve 19 and therefore outside the valve 19, so that accordingly the valve 19 is a component arranged externally with respect to the valve 18 and therefore outside the valve 18. Therefore, the valve 18 is preferably provided in addition to the valve 19, preferably the valve 19 is provided in addition to the valve 18. In particular, the valves 18 and 19 are formed, in particular completely, separately from one another and are therefore individual parts formed separately from one another. The respective valve 18, 19 and therefore the valve device 17 can be switched, in particular by preferably electrical actuation of the respective valve 18, 19 and therefore the valve device 17, between respective different switching states. For this purpose, for example, the temperature-control device 1 comprises an electronic computing device 20, which is particularly schematically shown and is also referred to as a control unit, by means of which the respective valve 18, 19 and therefore the valve device 17 can be actuated, in particular electrically or electronically. For this purpose, for example, the electronic computing device 20 can provide an in particular electrical actuation signal, wherein the valve 18, 19 can receive the respective actuation signal, by which the respective valve 18, 19 and therefore the valve device 17 is actuated. In this way, the respective valve 18, 19 and therefore the valve device 17 can be switched between different switching states, therefore switched back and forth. The respective switching state of the valve device 17 causes, for example, in particular precisely, one respective heat pump operating mode, so that because the valve device 17 can be switched into the different switching states, multiple heat pump operating modes of the temperature-control device 1 different from one another can be set, i.e. activated. Therefore, the temperature-control device 1 can be operated by means of the electronic computing device 20 and by means of the valve device 17 in the different heat pump operating modes. The temperature-control device 1 can be operated in heat pump operation and therefore as a heat pump, wherein the heat pump operating modes are different operating styles or operating modes of the heat pump.

In particular, the temperature-control device 1 enables the motor vehicle to advantageously be able to control the temperature, i.e. cool and/or heat, its interior, also referred to as a passenger cell or passenger compartment, which is formed by a structure of the motor vehicle designed, for example, as a self-supporting body, in particular such that by means of the heat pump and in the respective heat pump operating mode, the interior and the electrical energy storage device 7 and, for example, also the respective drive machine 4, 5 can particularly advantageously be controlled in temperature. In particular, for example, the interior can be controlled in temperature in such a way that the interior can be heated, i.e. heated up. In particular, the electrical energy storage device 7 can simultaneously advantageously be controlled in temperature, i.e. cooled and/or heated, so that, for example, the energy storage device 7 can be brought into an advantageous temperature range and/or kept in the temperature range. Unfavorable temperatures of the respective drive machine 4, 5 can also be avoided.

If, for example, the first temperature is greater than a predetermined first threshold value and the second temperature is greater than a predetermined second threshold value, for example, the temperature-control device 1 is transferred by means of the electronic computing device 20 into a first of the heat pump operating modes, in particular out of another heat pump operating mode, and in particular the temperature-control device 1 is kept in the first heat pump operating mode by means of the electronic computing device 20 when and as long as the first temperature is greater than the first threshold value and the second temperature is greater than the second threshold value. The second threshold value is, for example, a target value for the second temperature, and the first threshold value is, for example, a set point minimum of the first temperature, which is, for example, an outlet temperature of the chiller (first heat exchanger 8). In the first heat pump operating mode, the strands S1-5 of the temperature-control circuit 2 are interconnected with one another by means of the valve device 17, i.e. by means of the valves 18 and 19, such that the first strand S1, the second strand S2, and the fourth strand S4 are fluidically connected in series to one another and thus form a first overall strand G1, through which the temperature-control medium flows in the first heat pump operating mode, while the temperature-control medium does not flow through the third strand S3 and does not flow through the fifth strand S5. In FIG. 1, a compensation container is designated by 21, by means of which volume and quantity variations of the temperature-control medium in the temperature-control circuit 2 can be compensated for.

By means of the electronic computing device 20, the temperature-control device 1 is transferred into a second of the heat pump operating modes, in particular out of another one of the heat pump operating modes, when the second temperature is greater than the first threshold value and less than a third threshold value, which is greater than the first threshold value, and greater than the ambient temperature, wherein, for example, by means of the electronic computing device 20, the temperature-control device 1 is operated and kept in the second heat pump operating mode when and as long as the second temperature is greater than the first threshold value and less than the third threshold value and greater than the ambient temperature. The ambient temperature is also designated by TO. The third threshold value is, for example, a setpoint maximum for the outlet temperature of the chiller.

In the second heat pump operating mode shown in FIG. 2, the strands S1-5 of the temperature-control circuit 2 are interconnected with one another, in particular fluidically, by means of the valve device 17 such that the second strand S2 and the fourth strand S4 are fluidically connected in series to one another and thus form a second overall strand G2, through which the temperature-control medium flows, in particular in that the temperature-control medium is conveyed by means of the conveyor device 10 through the second overall strand G2. In the second heat pump operating mode, the temperature-control medium does not flow through the first strand S1, does not flow through the third strand S3, and does not flow through the fifth strand S5. It can be seen from FIG. 2 that in the second heat pump operating mode, the second overall strand G2 comprises a bypass line UL also referred to as a bypass or detour line, via which the temperature-control medium can bypass or does bypass the ambient air cooler 3. This means that in the second heat pump operating mode, the temperature-control medium flowing through the second overall strand G2 and therefore the bypass line UL bypasses the ambient air cooler 3 via the bypass line UL, therefore does not flow through the ambient air cooler 3, wherein in the present case, in the direction of flow of the temperature-control medium flowing through the overall strand G2, the bypass line UL is arranged upstream of the fourth strand S4 and downstream of the second strand S2.

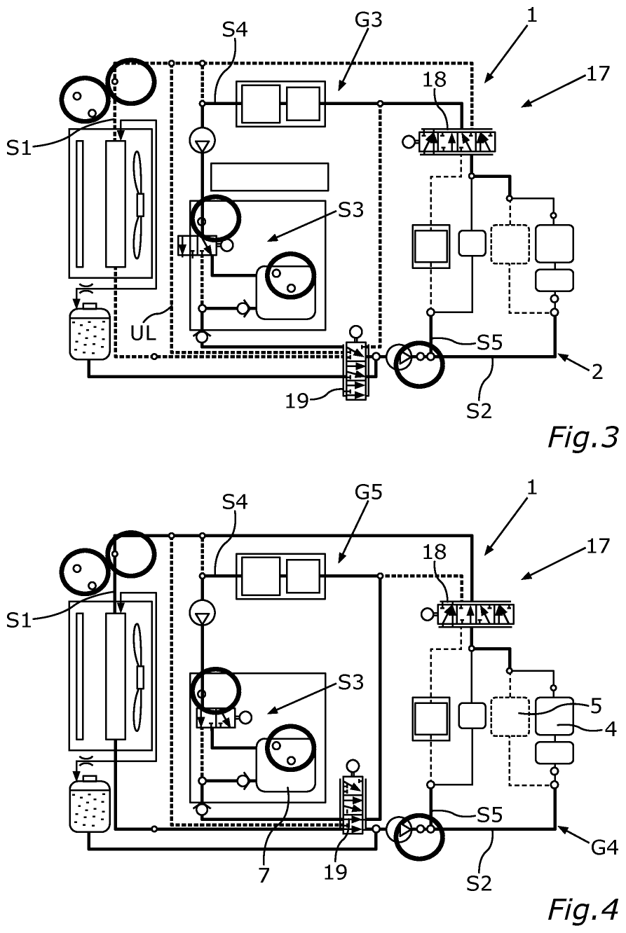

A third of the heat pump operating modes is illustrated in FIG. 3. For example, the temperature-control device 2 is transferred, i.e. switched, by means of the electronic computing device 20 into the third heat pump operating mode, in particular from another one of the heat pump operating modes, when the third temperature is greater than the fifth temperature and greater than the ambient temperature and the fifth temperature is less than a predetermined fourth threshold value, which is, for example, a threshold value different from the first threshold value, from the second threshold value, and from the third threshold value. By means of the electronic computing device 20, for example, the temperature-control device 1 is kept and operated in the third heat pump operating mode when and, for example, as long as the third temperature is less than the third threshold value and greater than the first threshold value and, for example, greater than a difference value, which results from the fifth temperature minus a value dependent in particular on the fifth temperature, so that, for example, the difference value is a value different from the first threshold value, from the second threshold value, from the third threshold value, and from the fourth threshold value. In the third heat pump operating mode, the strands S1-5 of the temperature-control circuit 2 are interconnected with one another by means of the valve device 17 and therefore by means of the valves 18 and 19 such that the second strand S2, the third strand S3, and the fourth strand S4 are fluidically connected in series to one another and thus form a third overall strand G3 through which the temperature-control medium flows, through which the temperature-control medium flows, for example, in that the temperature-control medium is conveyed by means of the conveyor device 10 through the third overall strand G3. In the third heat pump operating mode, the temperature-control medium does not flow through the first strand S1 and does not flow through the fifth strand S5 and, for example, also does not flow through the bypass line UL.

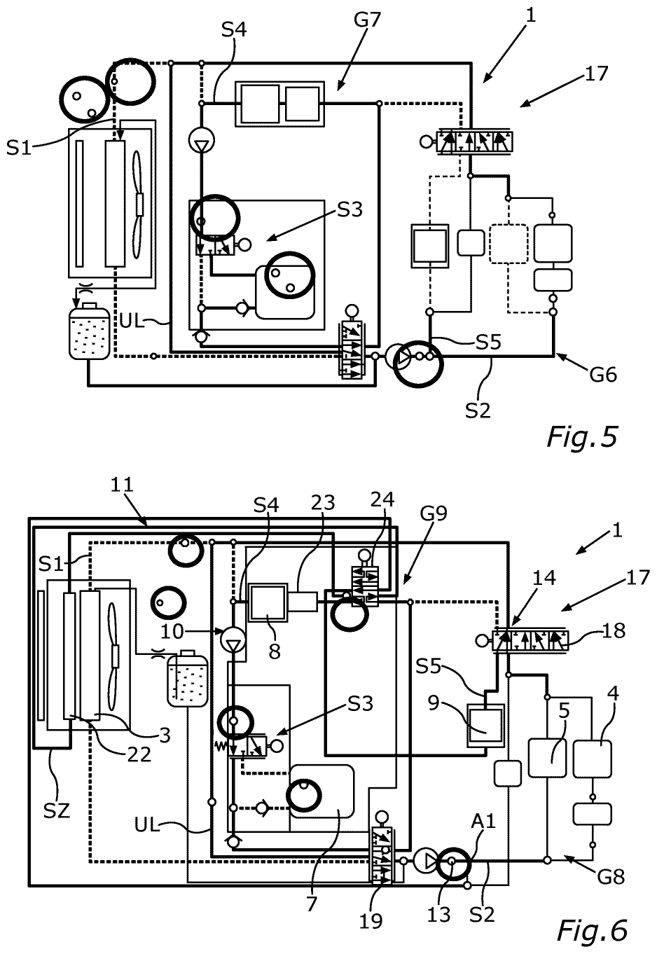

FIG. 4 illustrates a fourth of the heat pump operating modes of the temperature-control device 1. For example, the temperature-control device 1 is operated in the fourth heat pump operating mode by means of the electronic computing device 20 when the fifth temperature is greater than the fourth threshold value, the third temperature is greater than the first temperature, less than the third threshold value, and greater than the first threshold value, and the second temperature is greater than the second threshold value. In FIG. 5, a fifth of the heat pump operating modes is illustrated, wherein, for example, the electronic computing device 20 operates the temperature-control device 1 in the fifth heat pump operating mode when the fifth temperature is greater than the fourth threshold value, the third temperature is greater than the first temperature, less than the third threshold value, and greater than the first threshold value, and the second temperature is less than the second threshold value. If, for example, the fifth temperature is greater than the fourth threshold value, the temperature-control device 1 is thus transferred, i.e. switched, into the fourth heat pump operating modes from one of the other heat pump operating modes by means of the electronic computing device 20 when, in particular additionally, the third temperature is greater than the first temperature, less than the third threshold value, and greater than the first threshold value and the second temperature is greater than the second threshold value. If the fifth temperature is greater than the fourth threshold value, for example, the temperature-control device 1 is thus transferred, i.e. switched, into the fifth heat pump operating mode from another one of the heat pump operating modes by means of the electronic computing device 20 when, in particular additionally, the third temperature is greater than the first temperature, less than the third threshold value, and greater than the first threshold value, and the second temperature is less than the second threshold value. For example, the temperature-control device 1 is transferred, i.e. switched, into the third heat pump operating mode from another one of the heat pump operating modes by means of the electronic computing device 20 when the third temperature is greater than the fifth temperature and greater than the ambient temperature and the fifth temperature is less than the fourth threshold value, and, for example, the temperature-control device 1 is kept and operated in the third heat pump operating mode by means of the electronic computing device 20 when and as long as the third temperature is greater than the difference value, less than the third threshold value, and greater than the first threshold value.

For example, the temperature-control device 1 is operated and kept in the fourth heat pump operating mode by means of the electronic computing device 20 when and as long as the third temperature is greater than the first temperature, less than the third threshold value, and greater than the first threshold value and the second temperature is greater than the second threshold value, wherein this condition is also referred to as a maintenance condition or preservation condition. If, for example, the fifth temperature is greater than the fourth threshold value and, for example, at least one of the above-mentioned preservation conditions is no longer met, however, the temperature-control device 1 is switched by means of the electronic computing device 20, for example, when the fifth temperature is greater than the fourth threshold value, from the fourth heat pump operating mode to the fifth pump operating mode, wherein, for example, the temperature-control device 1 is operated and kept in the fifth pump operating mode by means of the electronic computing device 20 when and as long as the third temperature is greater than the first temperature, less than the third threshold value, and greater than the first threshold value and the second temperature is less than the second threshold value. The latter conditions are also referred to as second preservation conditions or second maintenance conditions. If, for example, the fifth temperature is greater than the fourth threshold value and at least one of the second preservation conditions is not (no longer) met, however, the temperature-control device 1 is switched by means of the electronic computing device 20, for example, from the fifth heat pump operating mode into the fourth heat pump operating mode, and the temperature-control device 1 is operated and kept by means of the electronic computing device 20, for example, in the fourth heat pump operating mode as long as and preferably only as long as the third temperature is greater than the first temperature, less than the third threshold value, and greater than the first threshold value and the second temperature is greater than the second threshold value.

FIG. 6 illustrates a sixth of the heat pump operating modes, wherein the temperature-control device 1 is operated by means of the electronic computing device 20 in the sixth heat pump operating mode when the second temperature is less than the second threshold value and the third temperature is less than the third threshold value and greater than the first threshold value.

It can be seen from FIGS. 4 to 6 that in the fourth heat pump operating mode, the strands S1-5 of the temperature-control circuit 2 are interconnected with one another by means of the valve device 17 such that the first strand S1 and the second strand S2 are fluidically connected to one another in series and thus form a fourth overall strand G4 through which the temperature-control medium flows, through which the temperature-control medium flows, in particular in that the temperature-control medium is conveyed by means of the conveyor device 10 through the fourth overall strand G4. In the fourth heat pump operating mode, the third strand S3 and the fourth strand S4 are fluidically connected in series to one another and thus form a fifth overall strand G5 through which the temperature-control medium flows, through which the temperature-control medium flows, in particular in that the temperature-control medium is conveyed through the fifth overall strand G5 by means of the conveyor device 10. In this case, the overall strands G4 and G5 are in particular fluidically separated from one another by means of the valve device 17. In the fourth heat pump operating mode, a flow of the temperature-control medium through the fifth strand S5 does not take place, so that the temperature-control medium does not flow through the fifth strand S5.

In the fifth heat pump operating mode illustrated in FIG. 5, the strands S1-5 of the temperature-control circuit 2 are interconnected with one another by means of the valve device 17 such that the second strand S2 forms a sixth overall strand G6, through which the temperature-control medium flows, in particular in that the temperature-control medium is conveyed by means of the conveyor device 10 through the sixth overall strand G6. In the fifth heat pump operating mode, the third strand S3 and the fourth strand S4 are fluidically connected in series to one another, due to which the third strand S3 and the fourth strand S4 form a seventh overall strand G7, through which the temperature-control medium flows, in particular in that the temperature-control medium is conveyed by means of the conveyor device 10 through the seventh overall strand G7. In the fifth heat pump operating mode, the overall strands G6 and G7 are fluidically separated from one another, in particular by means of the valve device 17. In addition, it is provided in the fifth heat pump operating mode that the temperature-control medium does not flow through the first strand S1 and also does not flow through the fifth strand S5. It can be seen from FIG. 5 that in the fifth heat pump operating mode, the bypass line UL is a component of the sixth overall strand G6 such that the bypass line UL is arranged or extends, in the direction of flow of the temperature-control medium flowing through the overall strand G6, upstream of the conveyor device 10 and downstream of the strand S2, in particular downstream of the respective drive machine 4, 5.

In the optional sixth heat pump operating mode illustrated in FIG. 6, the strands S1-5 are interconnected with one another by means of the valve device 17 such that the second strand S2 forms an eighth overall strand G8, through which the temperature-control medium flows, in particular in that the temperature-control medium is conveyed through the overall strand G8 by means of the conveyor device 10. In the sixth heat pump operating mode, the temperature-control medium flows through the fifth strand S5 and therefore through the heat exchanger 9, for example, such that the temperature-control medium is conveyed by means of the conveyor device 10 through the strand S5. In the sixth heat pump operating mode, the fifth strand S5 branches off at a branching point A1 from the eighth overall strand G8, wherein in the direction of flow of the temperature-control medium flowing through the overall strand G8, the branching point A1 is arranged upstream of the drive machine 4, 5 and downstream of the second measuring point, at which the second temperature is measured and, for example, the temperature sensor 13 is arranged. In the sixth heat pump operating mode, the strand S5 discharges at a discharge point M into the eighth overall strand G8, wherein the discharge point M is arranged, in the direction of flow of the temperature-control medium flowing through the overall strand G8, downstream of the drive machine 4, 5 and upstream of the second measuring point. In the sixth heat pump operating mode, a flow of the temperature-control medium through the first strand S1 does not take place, since, for example, the temperature-control medium bypasses the first strand S1 via the strand S5 and/or the bypass line UL, which is a component of the overall strand G8 in the sixth heat pump operating mode. In the sixth heat pump operating mode, the third strand S3 and the fourth strand S4 are fluidically connected in series to one another, due to which the strands S3 and S4 form a ninth overall strand G9, through which the temperature-control medium flows, in particular in that the temperature-control medium is conveyed by means of the conveyor device 10 through the overall strand. The overall strands G8 and G9 are in particular fluidically separated from one another by means of the valve device 17 in this case.

According to FIG. 6, the temperature-control device 1 comprises an ambient air heat exchanger 22, which is provided in particular additionally to the ambient air cooler 3 and additionally to the heat exchangers 8 and 9 and around which the mentioned ambient air can flow. For example, the ambient air heat exchanger 22 is arranged in an auxiliary strand SZ, wherein, for example, in the sixth heat pump operating mode, the auxiliary strand SZ and therefore the ambient air heat exchanger 22 are components of the overall strand G9 such that the auxiliary strand SZ, in the direction of flow of the temperature-control medium flowing through the overall strand G9, is arranged downstream of the third strand S3 and upstream of the fourth strand S4. Heat can be exchanged via the ambient air heat exchanger 22 between the ambient air flowing around and/or through the ambient air heat exchanger 22 and temperature-control medium flowing through the ambient air heat exchanger 22 in the sixth heat pump operating mode, in particular such that heat can pass from the ambient air to the temperature-control medium via the ambient air heat exchanger. This heat passing via the ambient air heat exchanger 22 to the temperature-control medium and originating from the surroundings or ambient air can be supplied, for example, to the chiller (heat exchanger 8) and therefore can be used via the chiller (heat exchanger 8) in order to control the temperature of the interior or air to be supplied to the interior and also referred to as cabin air. Furthermore, for example, the heat passed via the ambient air heat exchanger 22 and originating from the surroundings or ambient air, which has passed to the temperature-control medium, can be supplied to the interior and/or the heat exchanger 9, in particular via the coolant circuit, in which both the chiller (heat exchanger 8) and heat exchanger 9 are arranged. It can be seen that in the strand S4, an electrical heating element 23 is arranged in particular upstream of the heat exchanger 8, which is designed, for example, as an electrical flow heater. By means of the electrical heating element 23, the temperature-control medium flowing through the electrical heating element 23 or the strand S4 can be heated using electrical energy. Therefore, for example, in the sixth heat pump operating mode, electrical auxiliary heating can be implemented by means of the electrical heating element 23, in order to thus, for example, be able to control the temperature of the interior particularly advantageously. The sixth heat pump operating mode is in particular reasonable if neither the electrical energy storage device 7 nor the drive machine 4, 5 provides waste heat which can be used for the temperature control of the interior. In order to implement the heat pump operating mode, for example, the valve device 17 comprises, for example, a third valve 24 as an auxiliary valve, wherein the valves 18, 19, and 24 are designed, viewed in pairs, as components formed separately from one another and in particular arranged outside of one another.

By means of the fifth heat pump operating mode, for example, heat can be absorbed from the electrical energy storage device 7 and supplied to the chiller and, via this, for example, the cabin air or the interior. This is advantageous in particular if a heat excess prevails at the energy storage device 7, therefore the electrical energy storage device 7 can provide heat, in particular waste heat, which can be used to control the temperature of, in particular heat, the interior. The fourth heat pump operating mode enables heat to be absorbed from or out of the energy storage device 7 and to be supplied to the chiller and via this, for example, the cabin air and therefore the interior, which is advantageous in particular if a heat excess exists at the energy storage device 7. In the third heat pump operating mode, for example, heat can be absorbed out of or from the drive machine 4, 5 and supplied to the chiller and therefore the cabin air or the interior and/or the energy storage device 7 can be heated, in particular via the chiller. The third pump operating mode is advantageous in particular if the energy storage device 7 is cold, therefore has a low temperature, and a heat excess exists at the drive machine 4, 5, therefore the drive machine 4, 5 provides heat, in particular waste heat, which can be used to heat the interior and/or the energy storage device 7.

The second heat pump operating mode enables heat to be absorbed from the drive machine 4, 5 and supplied to the chiller and therefore, for example, the interior or the cabin air. This is advantageous in particular if the first temperature is greater than the ambient temperature. The first pump operating mode enables heat to be drawn or absorbed from the surroundings and, for example, the drive machine 4, 5 to be warmed up in this way and, for example, another part of the heat originating from the surroundings to be supplied to the chiller and therefore via the chiller to the cabin air or the interior, which is advantageous in particular if the first temperature is less than the ambient temperature.

It can be seen, for example, that in the fifth strand S5, a further electrical or electronic component 25 can be arranged, which can be, for example, a power electronics unit assigned in particular to the drive machine 5. In this case, for example, the heat exchanger 9 is arranged in a fifth branch and the component 25 is arranged in a sixth branch of the strand S5, wherein the fifth branch and the sixth branch can be fluidically connected in parallel to one another. It can also be seen, for example, that an in particular electrically operable fan 26 can be assigned to the ambient air cooler 3 and, for example, the ambient air heat exchanger 22, by means of which the ambient air can be conveyed in order to thus supply the ambient air cooler 3 and the ambient air heat exchanger 22 with the ambient air.

The conveyor device 10 comprises a first pump 27, which is arranged in the strand S2. In addition, the conveyor device 10 comprises an additional second pump 28, which is arranged in the strand S3. By means of the, for example, electrically operable pumps 27 and 28, the temperature-control medium can advantageously be conveyed through the temperature-control circuit 2 in the respective heat pump operating mode.

In the figures, lines through which the temperature-control medium does not flow are shown by dashed lines, and lines through which the temperature-control medium flows are shown by solid lines.

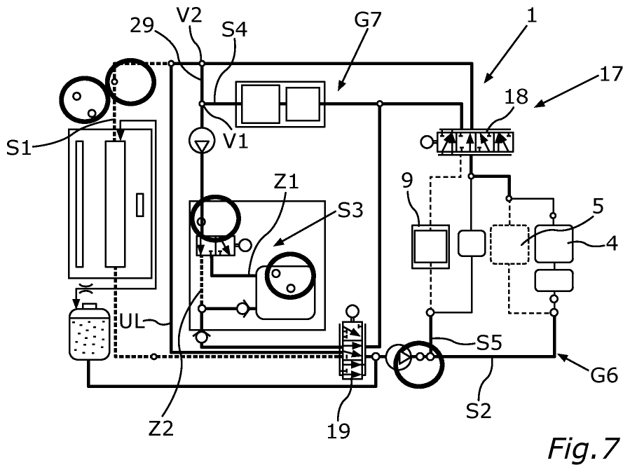

FIG. 7 shows a seventh operating mode of the temperature-control device 1, wherein the seventh operating mode is preferably a seventh heat pump operating mode. The seventh operating mode illustrated in FIG. 7 fundamentally corresponds to the fifth heat pump operating mode shown in FIG. 5, but with the following difference:

The temperature-control circuit 2 comprises a connecting line 29. In the seventh operating state, a part of the temperature-control medium flowing through the seventh overall strand G7 is branched off at a first connecting point V1 from the overall strand G7 and introduced into the connecting line 29, wherein the first connecting point is arranged, in the direction of flow of the temperature-control medium flowing through the overall strand G7, between the strands S3 and S4 and in this case downstream of the heat exchanger 8 (chiller) and upstream of the branches Z1 and Z2. The temperature-control medium branched off from the overall strand G7 and introduced into the connecting line 29 flows through the connecting line 29 and is guided by means of the connecting line 29 to a second connecting point V2, at which the temperature-control medium flowing through the connecting line 29 flows out of the connecting line 29 and into the bypass line UL and flows from this into the strand S2 and therefore into the sixth overall strand G6. Therefore, for example, the connecting line 29 belongs to the sixth overall strand G6, which is therefore fluidically connected in series to the strand S4 and fluidically connected in parallel to the strand S3, for example. In other words, the strand S4 branches into the strand S3 and the overall strand G6 comprising the bypass line UL and the strand S2, which discharges via the valve device 17, in particular via the valve 18, into the strand S4, into which the strand S3 also discharges. In contrast, for example, it is provided in the fifth heat pump operating mode that the sixth overall strand G6 and the seventh overall strand G7 are fluidically connected in parallel to one another.

### LIST OF REFERENCE SIGNS

| | |
|---|---|
| 1 | temperature-control device |
| 2 | temperature-control circuit |
| 3 | ambient air cooler |
| 4 | drive machine |
| 5 | drive machine |
| 6 | component |
| 7 | electrical energy storage device |
| 8 | first heat exchanger |
| 9 | second heat exchanger |
| 10 | conveyor device |
| 11 | temperature detection device |
| 12 | first temperature sensor |
| 13 | second temperature sensor |
| 14 | third temperature sensor |
| 15 | fourth temperature sensor |
| 16 | fifth temperature sensor |
| 17 | valve device |
| 18 | valve |
| 19 | valve |
| 20 | electronic computing device |
| 21 | compensation container |
| 22 | ambient air heat exchanger |
| 23 | electrical heating element |
| 24 | valve |
| 25 | component |
| 26 | fan |
| 27 | pump |
| 28 | pump |
| 29 | connecting line |
| A | branching point |
| G1 | first overall strand |
| G2 | second overall strand |
| G3 | third overall strand |
| G4 | fourth overall strand |
| G5 | fifth overall strand |
| G6 | sixth overall strand |
| G7 | seventh overall strand |
| G8 | eighth overall strand |
| G9 | ninth overall strand |
| M | discharge point |
| S1 | first strand |
| S2 | second strand |
| S3 | third strand |
| S4 | fourth strand |
| S5 | fifth strand |
| SZ | auxiliary strand |
| UL | bypass line |
| V1 | first connecting point |
| V2 | second connecting point |
| Z1 | first branch |
| Z2 | second branch |
| Z3 | third branch |
| Z4 | fourth branch |

1.-6. (canceled)

7. A temperature-control device for a motor vehicle, comprising:
a temperature-control circuit through which a temperature-control medium flows, and in which an ambient air cooler, a drive machine for driving the motor vehicle, an electrical energy storage device, a first heat exchanger that is also arranged in a coolant circuit through which a coolant flows and via which heat is exchangeable between the coolant and the temperature-control medium, and a second heat exchanger that is also arranged in the coolant circuit and via which heat is exchangeable between the coolant and the temperature-control medium are arranged;
a temperature detection device configured to detect a first temperature of the temperature-control medium upstream of the ambient air cooler, a second temperature of the temperature-control medium upstream of the drive machine, a third temperature of the temperature-control medium upstream of the energy storage device, an ambient temperature as a fourth temperature of the surroundings of the motor vehicle, and a fifth temperature of the electrical energy storage device; and
an electronic computing device configured to operate the temperature-control device:
in a first heat pump operating mode when the first temperature is greater than a predetermined first threshold value and the second temperature is greater than a predetermined second threshold value, wherein in the first heat pump operating mode, the ambient air cooler, the drive machine, and the first heat exchanger are connected in series and a flow of the temperature-control medium through the energy storage device and the second heat exchanger does not take place; and
in a second heat pump operating mode when the second temperature is greater than the first threshold value and less than a third threshold value, which is greater than the first threshold value, and greater than the ambient temperature, wherein in the second heat pump operating mode, the drive machine and the first heat exchanger are connected in series and a flow of the temperature-control medium through the ambient air cooler, the energy storage device, and the second heat exchanger does not take place.

8. The temperature-control device according to claim 7, wherein the electronic computing device is configured to operate the temperature-control device in a third heat pump operating mode when the third temperature is greater than the fifth temperature and greater than the ambient temperature and the fifth temperature is less than a predetermined fourth threshold value, wherein in the third heat pump operating mode, the drive machine, the energy storage device, and the first heat exchanger are connected in series and a flow of the temperature-control medium through the ambient air cooler does not take place.

9. The temperature-control device according to claim 8, wherein the electronic computing device is configured to operate the temperature-control device in a fourth heat pump operating mode when the fifth temperature is greater than the fourth threshold value, the third temperature is greater than the first temperature, less than the third threshold value, and greater than the first threshold value, and the second temperature is greater than the second threshold value, wherein in the fourth heat pump operating mode, the ambient air cooler and the drive machine are connected in series and are arranged in a first circuit strand through which the temperature-control medium flows, the energy storage device and the first heat exchanger are connected in series and are arranged in a second circuit strand, fluidically separated from the first circuit strand, through which the temperature-control medium flows, and a flow of the temperature-control medium through the second heat exchanger does not take place.

10. The temperature-control device according to claim 9, wherein the electronic computing device is configured to operate the temperature-control device in a fifth heat pump operating mode when the fifth temperature is greater than the fourth threshold value, the third temperature is greater than the first temperature, less than the third threshold value, and greater than the first threshold value, and the second temperature is less than the second threshold value, wherein in the fifth heat pump operating mode, the drive machine is arranged in a drive machine strand through which the temperature-control medium flows, the energy storage device and the first heat exchanger are connected in series and are arranged in an energy storage device strand, which is fluidically separated from the drive machine strand, through which the temperature-control medium flows, and a flow of the temperature-control medium through the ambient air cooler and the second heat exchanger does not take place.

11. The temperature-control device according to claim 10, wherein the electronic computing device is configured to operate the temperature-control device in a sixth heat pump operating mode when the second temperature is less than the second threshold value and the third temperature is less than the third threshold value and greater than the first threshold value, wherein in the sixth heat pump operating mode, the drive machine is arranged in the drive machine strand through which the temperature-control medium flows, the second heat exchanger is arranged in a first heat exchanger strand through which the temperature-control medium flows, a flow of the temperature-control medium through the ambient air cooler does not take place, the energy storage device and the first heat exchanger are arranged in a second heat exchanger strand, through which the temperature-control medium flows and are connected in series, and the second heat exchanger strand is fluidically separated from the drive machine strand and the first heat exchanger strand.

12. A motor vehicle comprising the temperature-control device according to claim 7.
